(19) United States
(12) Patent Application Publication
(10) Pub. No.: US 2012/0047527 A1
(43) Pub. Date: Feb. 23, 2012

(54) ELECTRONIC DEVICE AND METHOD FOR EMBEDDING PRODUCT INFORMATION IN VIDEOS WITH PRODUCT PLACEMENTS

(75) Inventors: CHUNG-I LEE, Tu-Cheng (TW); CHIEN-FA YEH, Tu-Cheng (TW); SHAN-CHUAN JENG, Tu-Cheng (TW); HO-I SUN, Tu-Cheng (TW); TSUNG-HSIN YEN, Tu-Cheng (TW); YU-FENG CHIEN, Tu-Cheng (TW); CHENG-FENG TSAI, Tu-Cheng (TW)

(73) Assignee: HON HAI PRECISION INDUSTRY CO., LTD., Tu-Cheng (TW)

(21) Appl. No.: 13/167,703

(22) Filed: Jun. 24, 2011

(30) Foreign Application Priority Data
Aug. 17, 2010 (TW) 99127419

(51) Int. Cl. H04N 7/025

(52) U.S. Cl. 725/32

(57) ABSTRACT

A method embeds product information in videos with product placements using an electronic device. The electronic device converts product information of products into advertisement information, and saves the advertisement information in an ad database. The advertisement information includes product images and advertisements of the products. The electronic device exports the advertisement of a presented product displayed on a display device from the ad database according to the product images during the video broadcasts. The advertisement of the presented product is displayed on the display device.

### BACKGROUND

1. Technical Field

Embodiments of the present disclosure generally relate to advertisement displaying devices and methods, particularly to an electronic device and method for embedding product information in videos with product placements.

2. Description of Related Art

Product placement is increasingly becoming a popular form of advertising in media environments, especially with the growing use of digital recording devices, such as TIVO and DVR, that allow viewers to skip commercials. While there are numerous advantages to this marketing strategy, one major disadvantage is that the viewers have no concrete information on what the product is or even where to purchase it. This lack of information can influence the effectiveness of this type of advertising.

### BRIEF DESCRIPTION OF THE DRAWINGS

FIG. 1 is a block diagram of one embodiment of an electronic device including an embedding unit.

FIG. 2 is a block diagram of one embodiment of function modules of the embedding unit of FIG. 1.

FIG. 3 is a flowchart illustrating one embodiment of a method for embedding product information in TV programs with product placements.

FIG. 4 is a schematic diagram illustrating one embodiment of comparing product images saved in an ad database with a presented product.

### DETAILED DESCRIPTION

In general, the data “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

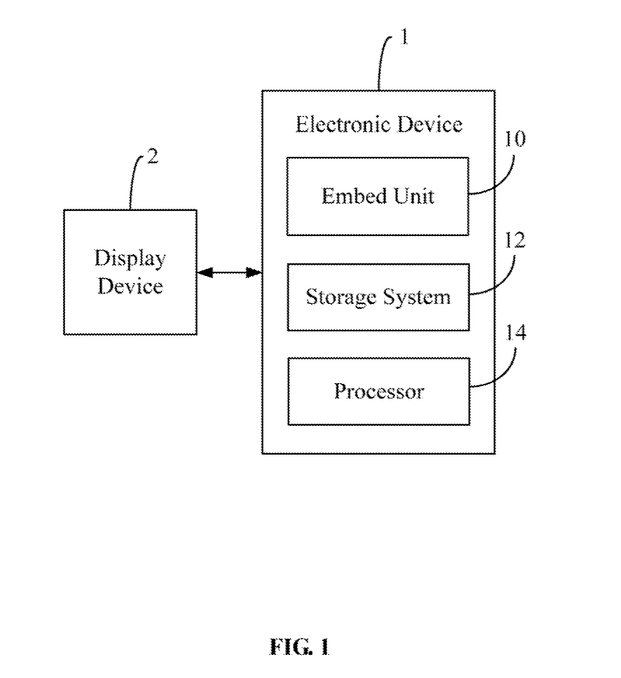

FIG. 1 is a block diagram of one embodiment of an electronic device 1 including an embedding unit 10. In the embodiment, functions of the embedding unit 10 are implemented by the electronic device 1. The embedding unit 10 can embed advertisements of products presented in a video, such as a TV program, and display the advertisements on a display device 2 that is electronically connected to the electronic device 1 via a wired or wireless connection. In one embodiment, the products may be cars, watches, or clothes. The advertisements of the presented products may be presented using, for example, text, audio, advertisement files, Web advertisements, and/or shopping websites. The video may be a TV program, such as a movie, a TV series, or any other entertainment show in TV or computer.

In one embodiment, the electronic device 1 may be a computer, a TV, a portable electronic device, or any other electronic device that includes a storage system 12 and at least one processor 14.

The embed unit 10 is configured to convert product information of products uploaded by companies to advertisement information, and save the advertisement information in an advertisement (ad) database. In the embodiment, the advertisement information includes product images taken from different angles and advertisements of the products. When a video broadcasts, the embed unit 10 exports the advertisement for each of the presented products from the ad database, and displays the advertisement of each of the presented products on the display device 2.

In one embodiment, the embed unit 10 displays the advertisement in the periphery of a display screen of the display device 2 concurrently with the video, such as an upper left corner, an upper right corner, a lower left corner, or a lower right corner of the display device 2. In another embodiment, the embed unit 10 displays the advertisement on the display device 2 when the video ends or is paused.

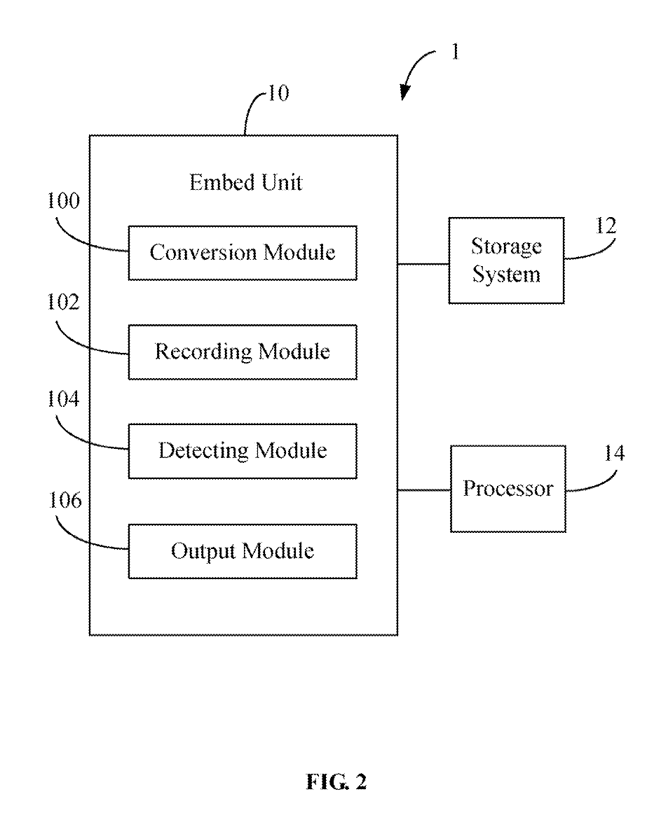

FIG. 2 is a block diagram of one embodiment of function modules of the embed unit 10 of FIG. 1. In one embodiment, the embed unit 10 includes a conversion module 100, a recording module 102, a detecting module 104, and an output module 106. Each of the modules 100-106 may be a software program including one or more computerized instructions that are stored in the storage system 12 and executed by the processor 14.

In one embodiment, the storage system 12 may be a magnetic or an optical storage system, such as a hard disk drive, an optical drive, or a tape drive.

Before the display device 2 broadcasts a video, the conversion module 100 converts product information of products that have been uploaded by companies into advertisement information. In the embodiment, the advertisement information includes product images taken from different angles and advertisements of the products.

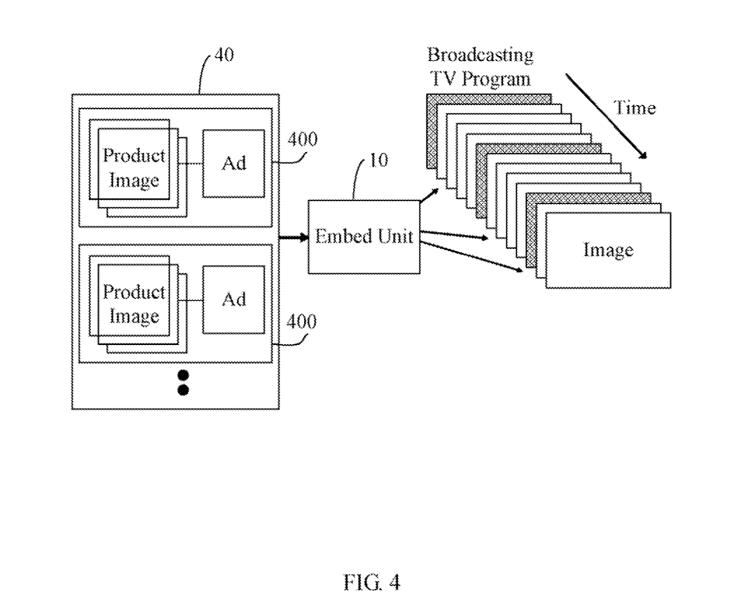

The recording module 102 saves the advertisement information in an ad database. As described in FIG. 4, the ad database 40 stores two products' advertisement information 400, and each of the two products' advertisement information 400 includes a plurality of product images and an advertisement.

In the embodiment, the ad database can be an image file or a movie file that is compatible with the video, and the movie file may be in format of a MPEG-2, MPEG-4, or an AVC format, or other formats.

When the display device 2 broadcasts the video, the detecting module 104 exports an advertisement of a presented product from the ad database 40 according to images of the product presented on the video. In detail, the detecting module 104 detects the ad database 40 within a predetermined period to determine whether any product images are similar to the presented product. If there is a plurality of product images similar to the presented product, the detecting module 104 calculates a similarity between each of the product images with the presented product. If the similarity between one of the product images (i.e., product image M) and the presented product is greater than a predetermined threshold, the detecting module 104 will determine that the advertisement information including the product image M belongs to the presented product, and the advertisement included in the advertisement information is the advertisement of the presented product. In the embodiment, the detecting module 104 calculates the similarity by calculating a distance between an average pixel value of each of the product images and an average pixel value of the image of the presented product.

For example, if the product images in the advertisement information 400a and 400b are similar to the presented product, the detecting module 104 first calculates a similarity between each of the product images in the advertisement information 400a and the image of the presented product, and then calculates a similarity between each of the product images in the advertisement information 400b and the image of the presented product. If the calculated similarity of one of the product images in the advertisement information 400a is greater than the predetermined threshold, the detecting module 104 determines that the advertisement in the advertisement information 400a is the advertisement of the presented product.

The output module 106 exports the advertisement of the presented product from the advertisement information 400a, and displays the advertisement of the presented product on the display device 2, so a viewer can browse the advertisement from the display device 2. In one embodiment, the output module 106 displays the advertisement in the periphery of a display screen of the display device 2 concurrently with the video, such as an upper left corner, an upper right corner, a lower left corner, or a lower right corner of the display device 2. In another embodiment, the output module 106 displays the advertisement on the display device 2 when the video ends or is paused.

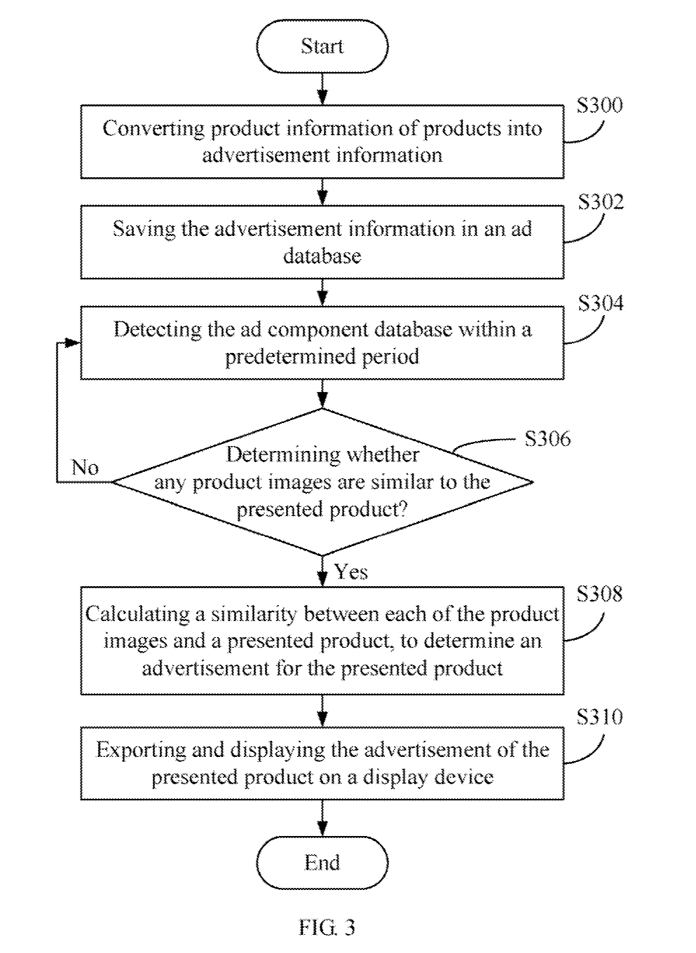

FIG. 3 is a flowchart illustrating one embodiment of a method for embedding product information in TV programs with product placements. Depending on the embodiment, additional blocks may be added, others removed, and the ordering of the blocks may be changed.

In block S300, the conversion module 100 converts product information of products that is uploaded by companies into advertisement information. In the embodiment, the advertisement information includes product images taken from different angles and advertisements of the products.

In block S302, the recording module 102 saves the advertisement information of the products in an ad database. As illustrated in FIG. 4, the ad database 40 stores two products' advertisement information 400, and each of the two products' advertisement information 400 includes a plurality of product images and an advertisement.

When the display device 2 displays the TV program, in block S304, the detecting module 104 detects the ad database 40 within a predetermined period to determine whether any product images are similar to the presented product in block S306. If some product images in the ad database 40 are similar to the presented product, the flow goes to block S308. If there are no product images similar to the presented product, the flow returns to block S304.

In block S308, the detecting module 104 calculates a similarity between each of the product images and the presented product, to determine an advertisement for the presented product. In the embodiment, if the similarity between one of the product images and the presented product is greater than a predetermined threshold, the detecting module 104 determines that the advertisement information (such as the advertisement information 400a illustrated in FIG. 4) including the product image belongs to the presented product, and the detecting module 104 determines that the advertisement in the advertisement information 400 is the advertisement of the presented product. In the embodiment, the detecting module 104 calculates the similarity by calculating a distance between an average pixel value of each of the product images and an average pixel value of the image of the presented product.

In block S310, the output module 106 exports the advertisement of the presented product from the advertisement information 400a and displays the advertisement of the presented product on the display device 2, so a viewer can browse the advertisement from the display device 2. In the embodiment, the output module 106 can display the advertisement in the periphery of a display screen of the display device 2 concurrently with the TV program, or display the advertisement on the display device 2 when the TV program ends or is paused.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for embedding product information in videos with product placements using an electronic device, the method comprising:
converting product information of products into advertisement information, the advertisement information comprising product images of the products and an advertisement of the products;
saving the advertisement information of the products in an ad database;
exporting an advertisement of a product presented on a video from the ad database according to an image of the presented product during the video broadcasts; and
displaying the advertisement of the presented product on a display device that is electronically connected to the electronic device.

2. The method as described in claim 1, wherein the exporting block comprises:
detecting whether any product images in the ad database are similar to the presented product within a predetermined period;
calculating a similarity between the product images and the image of the presented product;
upon the condition that the similarity between one of the product images and the image of the presented product is greater than a predetermined threshold, determining that the advertisement information comprising the product image belongs to the presented product; and
determining that the advertisement in the advertisement information is the advertisement of the presented product.

3. The method as described in claim 1, wherein the displaying block comprises:
displaying the advertisement of the presented product in the periphery of a display screen of the display device concurrently with the video; or
displaying the advertisement of the presented product on the display device when the video ends or is paused.

4. The method as described in claim 1, wherein the video is a movie, a TV series, or an entertainment show.

5. The method as described in claim 1, wherein the advertisement is delivered using text, audio, advertisement files, web advertisements, and/or shopping websites.

6. The method as described in claim 1, wherein the ad database is an image file or a movie file that is compatible with the video.

7. The method as described in claim 6, wherein the movie file is in a MPEG-2, MPEG-4, or an AVC format.

8. An electronic device, comprising:
at least one processor;
a storage system; and
one or more modules that are stored in the storage system and executed by the at least one processor, the one or more modules comprising instructions:
to convert product information of products into advertisement information, the advertisement information comprising product images of the products and an advertisement of the products;
to save the advertisement information of the products in an ad database;
to export an advertisement of a product presented on a video from the ad database according to an image of the presented product during the video broadcasts; and
to display the advertisement of the presented product on a display device that is electronically connected to the electronic device.

9. The electronic device as described in claim 8, wherein the instructions detect whether any product images in the ad database are similar to the presented product within a predetermined period, calculate a similarity between the product images and the image of the presented product, if the similarity between one of the product images and the image of the presented product is greater than a predetermined threshold, determine that the advertisement information comprising the product image belongs to the presented product, and determine that the advertisement in the advertisement information is the advertisement of the presented product.

10. The electronic device as described in claim 8, wherein the instructions display the advertisement of the presented product in the periphery of a display screen of the display device concurrently with the video.

11. The electronic device as described in claim 8, wherein the instructions display the advertisement of the presented product on the display device when the video ends or is paused.

12. The electronic device as described in claim 8, wherein the video is a movie, a TV series, or an entertainment show.

13. The electronic device as described in claim 8, wherein the advertisement is delivered using text, audio, advertisement files, web advertisements, and/or shopping websites.

14. The electronic device as described in claim 8, wherein the ad database is an image file or a movie file that is compatible with the video.

15. The electronic device as described in claim 14, wherein the movie file is in a MPEG-2, MPEG-4, or an AVC format.

16. A non-transitory storage medium having stored thereon instructions that, when executed by a processor of an electronic device, causes the processor to perform a method for embedding product information in videos with product placements using an electronic device, the method comprising:
converting product information of products into advertisement information, the advertisement information comprising product images of the products and an advertisement of the products;
saving the advertisement information of the products in an ad database;
exporting an advertisement of a product presented on a video from the ad database according to an image of the presented product during the video broadcasts; and
displaying the advertisement of the presented product on a display device that is electronically connected to the electronic device.

17. The storage medium as described in claim 16, wherein the exporting bock comprises:
detecting whether any product images in the ad database are similar to the presented product within a predetermined period;
calculating a similarity between the product images and the image of the presented product;
upon the condition that the similarity between one of the product images and the image of the presented product is greater than a predetermined threshold, determining that the advertisement information comprising the product image belongs to the presented product; and
determining that the advertisement in the advertisement information is the advertisement of the presented product.

18. The storage medium as described in claim 16, wherein the displaying block comprises:
displaying the advertisement of the presented product in the periphery of a display screen of the display device concurrently with the video; or
displaying the advertisement of the presented product on the display device when the video ends or is paused.

19. The storage medium as described in claim 16, wherein the advertisement is delivered using text, audio, advertisement files, web advertisements, and/or shopping websites.

20. The storage medium as described in claim 16, wherein the ad database is an image file or a movie file that is compatible with the video, and the movie file is in a MPEG-2, MPEG-4, or an AVC format.
